(19) United States
(12) Patent Application Publication
(10) Pub. No.: US 2010/0333178 A1
(43) Pub. Date: Dec. 30, 2010

(54) System and Method for Unique User Identification via Correlation of Public and Private Data by a Third-Party

(76) Inventor: Brian J. Suthoff, Boston, MA (US)

Correspondence Address: BRIAN J. SUTHOFF, 33 BAY STATE ROAD, APT. 6, BOSTON, MA, 02215, US

(21) Appl. No.: 12/494,659

(22) Filed: Jun. 30, 2009

(51) Int. Cl. G06F 21/20

(52) U.S. Cl. 726/4

(57) ABSTRACT

The present invention is a system and method to provide the unique and persistent user identification of networked electronic devices (e.g., computers, mobile phones, game consoles, set-top boxes, etc.) and/or the users (the first-party) by correlating the public information received by a second-party with the private information available to a network access provider or other third-party and then the capability for the third-party to uniquely identify users/devices and provide data to second-parties. The invention is able to uniquely & persistently identify devices and users on a network without exchanging uniquely identifying information between the user/device and the content provider responding to the request (e.g., no reliance on passwords, cookies, challenge/response, encrypted strings.).

hones, game consoles, set-top boxes, etc.) and/or the users (the first-party) to second-parties by correlating the public information received by a second-party with the private information available an other third-party, such as a network access provider or other service provider.

The first-party is defined as the originator of a request for content, typically a computer, mobile phone or other networked device. The second-party is the recipient of the content request, typically a web site and its associated advertising and content delivery systems. The third-party is does not request the content or provide the requested content but transmits the request or collects data about the request from the network access provider (NAP, e.g., internet service provider (ISP), mobile network operator (MNO)) or directly from the first-party.

Public data are considered to include those data contained within the communication sent between the first and second parties. Private data are considered to include those data communicated between the first-party and the NAP and/or between the first-party and the third-party.

A common challenge affecting many service and application providers is that communication networks do not always provide for the unique and persistent identification of connected devices and/or users. For example, internet protocol (IP) networks assign IP addresses to devices when the devices connect to the network. A common analogy is to compare the IP address to a postal mail address. If the address remained constant, then recipients of communications (or letters in the analogy) would uniquely and persistently be able to identify the sender based on the address. However, IP addresses are often assigned temporarily. Over a period of time, the same device may be assigned many different addresses and/or the same address may at different times be assigned to different devices.

Additionally, application protocols running on communications networks (e.g., http for web services, RTP for streaming media, etc.) are often described as “stateless”, meaning that no or a limited state is maintained from one request or session to the next. Therefore, a web server may receive multiple requests for content from a user device web browser, but the web server is not able to correlate those requests to one another. Nor are augmenting systems, such as an advertising serving system, able to correlate the many requests by a unique device/user to different servers back to that unique device or user.

One known method used to address these deficiencies is for web servers to place “cookies” into the device. A cookie is a short segment of code that a web site operator downloads through the network into the device's program memory or storage space. The cookie may then function as an identifier and also gather and store information about the device's user and the user's activities. Each time a particular web site is accessed, the web site operator is able to use the cookie to retrieve the stored information. However, not all devices support cookies. Many cookies may also be blocked, refused or erased by the device or user. In many networks, this reduces the functionality, reliability and value of using cookies.

Another method sometimes used to address these deficiencies is to inject new, sometimes encrypted, information into the device's/user's communication between the device/user and the server. Unfortunately, this method is also deficient in many ways. Such a method typically requires action by the user and direct one-to-many and many-to-many coordination between the first and second parties, increasing complexity of the service. Also, such methods may fail to protect the user's privacy. Although the new information injected into the communication may be non-personally identifiable information (PII), if the said information is used repeatedly the said information can still be used as a tracking mechanism.

### SUMMARY OF THE INVENTIONS

The present invention is a system and method for unique and persistent user identification of first-parties to second-parties via correlation of public and private data by a third-party, without exchanging uniquely identifying information directly between the first-party and the second-party, which is made up of the following required elements: a data repository, a data processing and analytics routine, a data center accessible to subscribed second-parties, and an application programming interface (API) to provide access to second-parties. These elements are connected over a data computer network, either wired or wireless, and are not required to reside in the same physical location. Further, this invention can also have one or more of the following: A computer program residing on the first-party device to collect public and private data and communicate those data to the data repository.

The data repository is a computer-based processing and storage platform that receives and manages public and private information that is transported over the NAP facilities, provided by the device/user directly to the third-party, or collected from other internal systems of the NAP or third-party.

The data processing and analytics routine is a computer-based software system that analyzes and processes information provided by the data repository. The said routine may reside on either or both of the data repository and the data center. The data process and analytics routine correlates public and private transactional data, stores users' histories and creates anonymous aliases for users. Optionally, the said routine may also produce value-added information using techniques such as data mining, behavioral analytics, statistical analysis, transaction log analysis and artificial intelligence. The value-added information includes, but is not limited to, demographics, behavioral profiles, and usage statistics and metrics.

The data center is a computer-based platform that manages and stores the processed data and is designed to be accessible by second-parties. The data center may generate additional anonymous aliases to obscure the true identity of the users from the second-party. The data center is accessed over a data network, wired or wireless, by second-parties.

The API is a programmatic interface that allows second-parties to submit public information, received over a data network, related to a content or service request and receive the anonymous user identification, via the anonymous alias(es) generated in the data repository and data center, and some or all of the processed data.

The present invention also includes a method of anonymously identifying devices or users via the correlation of public and private data, which consists of the following steps: collecting both publicly and privately available data; processing, correlating and storing this data; generating anonymous aliases to be associated with the stored data; and consistently and persistently resolving the identity of first-party users to second-party servers. The present invention may also include one or more of the following steps: analyzing and mining the stored information to develop value-added data; providing value-added data to second-parties.

### DESCRIPTION OF THE DRAWINGS

FIG. 1—System architecture

FIG. 2—Method flow diagram

FIG. 3—Alternate method flow diagram

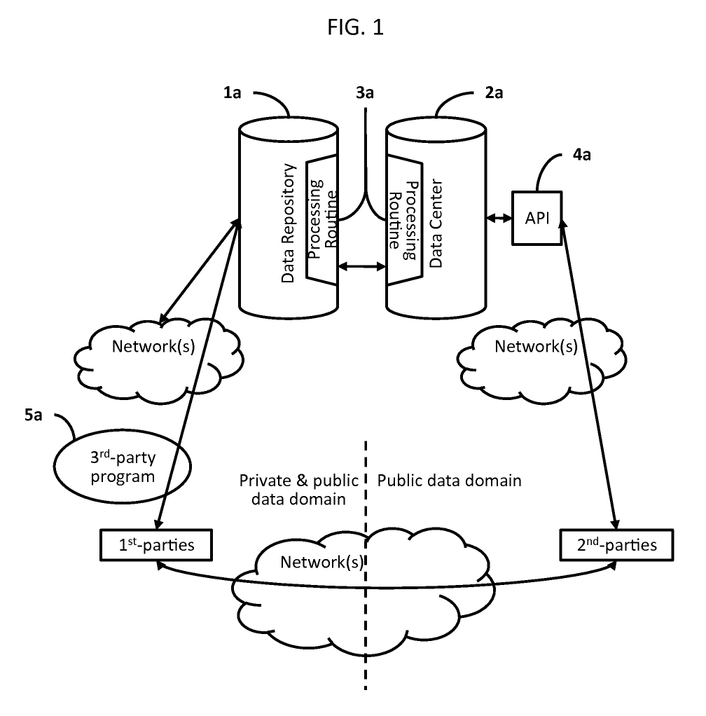

FIG. 1 illustrates the required and optional components of the invention. A 1a data repository is connected to, and receives public and private date from, one or more networks or 5a computer programs on user devices over a data network. A 2a data center is connected to the 1a data repository and the 4a API over a data network. A 3a data processing and analytics routine resides on the either or both the data repository and data center. A 4a application programming interface (API) is connected to the 3a data center by a data network and provides connectivity and access to the second-parties. The elements comprising this system are not required to reside in the same physical location. Further, this invention can also have one or more of the following: A 5a computer program residing on the first-party device to collect public and private data and communicate those data to the data repository.

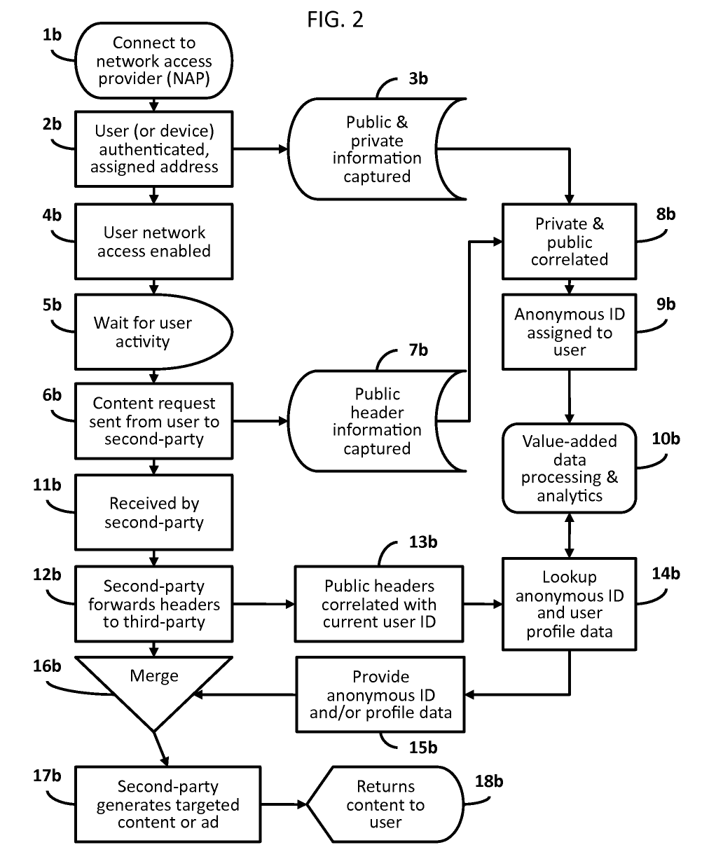

FIG. 2 illustrates the flow of a typical request by a user for some content (e.g., web page, video, etc.) over a network such as a mobile data network, fixed data network or internet and how the components of the invention work together.

When a user or device, the first-party, first connects 1b to a network access provider, a 2b authentication process is initiated that causes 3b public and private information to be transmitted over the network. This private information typically includes data such as customer ID, serial number, username/password, etc. Both the public and private data are 3b captured and stored in the data repository.

Assuming the user is properly authenticated, 4b network access is enabled. The user may have just turned on his networked device, but after some wait 5b the user will send a request for content 6b over the network. Optionally, the content request is transported over the network access provider's facilities and the outgoing/incoming, public information associated with that request is 7b captured and stored 8b in the data repository. The network access provider may also insert additional public information into the 6b outgoing content request to assist 13b in user identification. This same process 5b-8b will occur many times as the user continues to request content.

Autonomous of the content request process, the data repository accumulates multiple content requests and uses 8b data correlation and aggregation techniques to process information from 2b user authentication and the 6b subsequent content requests. An anonymous alias 9b is also generated and used to obscure and protect the true identity of the user from the second-party. The anonymous alias may be generated on a real-time, as-needed basis or an alias may be reused for an appropriate length of time. The processed data is then passed to the data center for 10b optional, additional value-added processing and analysis.

Continuing with 6b user's content request, the request is 11b received by the second-party who is offering some content or application or service. The second-party then uses the invention API to 12b forward public information extracted from the network and application headers to the third-party. The system components then work together to 13b correlate the public information provided with private information previously collected to 14b identify the user, select the anonymous alias (or ID) and optionally select the value-added profile data. The anonymous alias and/or profile data are then 15b provided to the second-party where they are 16b processed with the content request to 17b generate the requested content. The 18b content is then returned to the user who made the request.

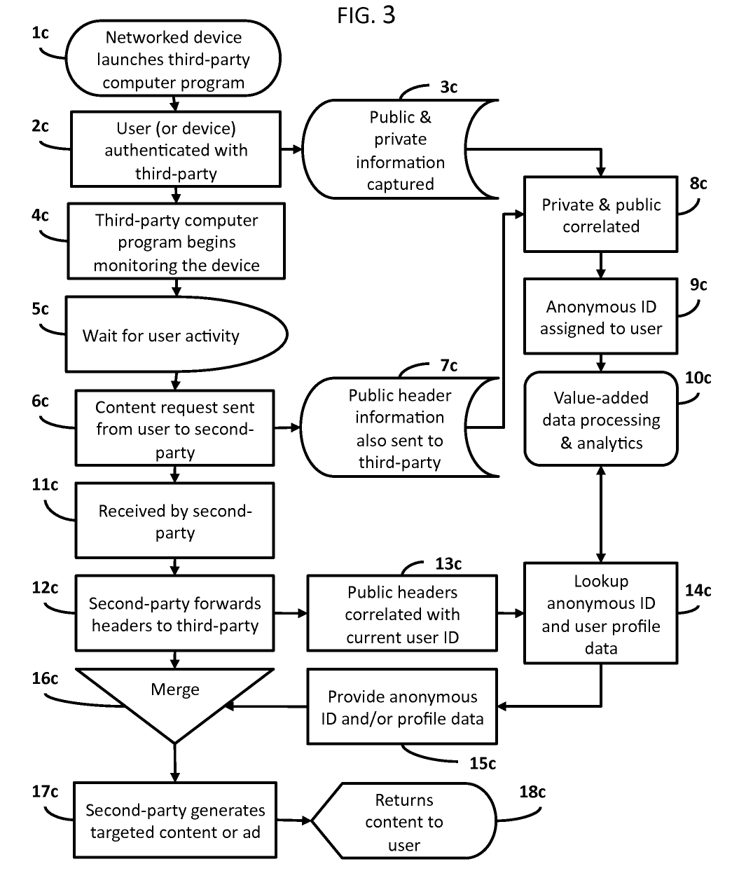

The same method and system may be used with another trusted, user-approved provider (another third-party to the content request) without the participation of the NAP. In this alternative implementation, another user authentication and identification step is performed; independent of that required by the NAP. FIG. 3 illustrates this alternative implementation. In this alternative, a 1c computer program may operate on the first-party device to 2c authenticate and identify the device or user. The computer program then monitors the device and notice changes in network connectivity, network addressing and the content requests. The other steps are similar to those already described in FIG. 1 and duplicated in FIG. 2 for clarity.

While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustration only and so that this disclosure will be thorough, complete and will fully convey the full scope of the invention to those skilled in the art. Indeed, many modifications and other embodiments of the invention will come to mind of those skilled in the art to which this invention pertains, and which are intended to be and are covered by both this disclosure, the drawings and the claims.

It should be understood that it is within the scope of this invention to cover the base claim (i.e., claim 1) plus one or more of the various optional limitations added in the dependent claims, which either directly or indirectly depend from claim 1.

What is claimed is:

1. A system for user identification via correlation of public and private data by a third-party comprising: —a computer-based processing and storage platform as a data repository for both public and private data—a computer-executable routine to analyze and process data provided by the data repository—a computer-based data center platform as processing and storage facility for more processed data—a computer-executable routine providing an application programming interface (API) to parties requesting data from the data center—an optional computer program built to operate on the first-party device.

2. The invention of [claim 1] wherein the data repository, data center and optional computer program are connected to and communicate over a wired or wireless computer network

3. The invention of [claim 1] wherein the computer-executable routine to analyze and process data may reside on either, or both, the data center and data repository.

4. The invention of [claim 1] wherein the API resides with, or is connected via a wired or wireless computer network to, the data center.

5. The invention of [claim 1] wherein the optional computer program resides on the first-party's device.

6. The invention of [claim 1] wherein the data repository resides where private data is logically retained by the entity to which it was entrusted. For example, if the NAP is providing private data from the network authentication process, the data repository should reside within the operating domain of the NAP.

7. A method for user identification via correlation of public and private data by a third-party comprising: A collecting public and private data during an authentication process; B collecting public data during a request for some content or service; C aggregating, analyzing and correlating of public and private data to enable unique identification of first-parties and storage of transaction and usage histories; D receiving requests from second-parties for unique identification; E providing unique identification and/or value-added informational data to second-parties.

8. The invention of [claim 7] wherein private data comprises identification data provided by the device or by the user but not transmitted to second parties, such as username, phone number or MSISDN, IMEI, serial number, MAC address, private IP address, gender, age, home zip or postal code, current location, etc.

9. The invention of [claim 7] wherein public data comprises more widely available data transmitted between the first and second parties during a request for content or a service, such as public IP address, other IP headers, HTTP application headers, SIP application headers, etc.

10. The invention of [claim 7] further comprising step C wherein a new, non-PII, anonymous identifier is associated with the aggregated data to make it anonymous and protect the identity of the first party.

11. The invention of [claim 7] further comprising step C wherein public and private data are correlated as needed to map public data to the said anonymous alias

12. The invention of [claim 7] further comprising step D wherein public data received by the second-party is provided to the third-party.

13. The invention of [claim 7] further comprising step D wherein public data is used by the third-party to look-up the identity of profile of the unique first-party.

14. The invention of [claim 7] further comprising step E wherein the unique identifier and profile are then delivered to the second party.
